(19) United States
(12) Patent Application Publication
(10) Pub. No.: US 2022/0335280 A1
(43) Pub. Date: Oct. 20, 2022

(54) ARTIFICIAL INTELLIGENCE SEMICONDUCTOR PROCESSOR AND OPERATING METHOD OF ARTIFICIAL INTELLIGENCE SEMICONDUCTOR PROCESSOR

(71) Applicant: Electronics and Telecommunications Research Institute, Daejeon (KR)

(72) Inventor: Hyeji KIM, Daejeon (KR)

(73) Assignee: Electronics and Telecommunications Research Institute, Daejeon (KR)

(21) Appl. No.: 17/550,441

(22) Filed: Dec. 14, 2021

(30) Foreign Application Priority Data
Apr. 14, 2021 (KR) 10-2021-0048554

(51) Int. Cl. G06N 3/063; G06F 11/30

(52) U.S. Cl. CPC G06N 3/063; G06F 11/3058

(57) ABSTRACT

Disclosed is an artificial intelligence semiconductor processor which includes a neural network computational accelerator that implements a neural network based on neural network configuration information, and a control circuit that adjusts precision of the neural network configuration information based on device information, and the control circuit adjusts the precision of the neural network configuration information such that neural network processing is performed by using a resource within a resource limit.

### CROSS-REFERENCE TO RELATED APPLICATIONS

This application claims priority under 35 U.S.C. § 119 to Korean Patent Application No. 10-2021-0048554 filed on Apr. 14, 2021, in the Korean Intellectual Property Office, the disclosures of which are incorporated by reference herein in their entireties.

### BACKGROUND

Embodiments of the present disclosure described herein relate to an electronic device, and more particularly, relate to an artificial intelligence semiconductor processor that adaptively adjusts the amount of computation depending on a resource limit and a condition of operating performance and an operating method of the artificial intelligence semiconductor processor.

As the amount of data used in daily life increase, a technology for automatically recognizing or classifying data is being developed. The technology is called “artificial intelligence” or “artificial neural network”. The artificial intelligence or artificial neural network requires a considerable lot of iterative and parallel operations. Accordingly, unlike a typical processor, an artificial intelligence semiconductor processor specialized in supporting a considerable lot of iterative and parallel operations are being studied.

As the field of application of the artificial intelligence semiconductor processor expands, the research into the application of the artificial intelligence semiconductor processor to an embedded device such as a smartphone or a smart pad is in progress. The embedded device includes a limited resource compared to a computer. For this reason, the artificial intelligence semiconductor processor to be applied to the embedded device has to be implemented so as to use the limited resource.

An artificial intelligence semiconductor has a structure with the great number of operations per square millimeter (operations/mm2) for the purpose of processing a complex neural network processing at high speed. The integrated structure causes a large current amount per unit area in a high-speed operation of the artificial intelligence semiconductor and increases power consumption and a temperature (or heat generation). The increase in power consumption and temperature caused by operations based on a highly integrated structure may cause an abnormal operation of the artificial intelligence semiconductor. To prevent the abnormal operation, a technique for controlling (or limiting) a temperature and power consumption by adjusting an operating frequency or a voltage level of the artificial intelligence semiconductor may be used. The restriction of the operating frequency or voltage level may cause a decrease in an object recognition speed of the artificial intelligence semiconductor, thereby causing the reduction of the performance of recognition. Accordingly, a device or a method for controlling power consumption and a temperature without decreasing a recognition speed is required.

### SUMMARY

Embodiments of the present disclosure provide a control circuit to control a power and a temperature of an artificial intelligence semiconductor processor without decreasing an operating speed of the artificial intelligence semiconductor processor and an operating method of the artificial intelligence semiconductor processor for controlling the power and the temperature thereof without decreasing the operating speed thereof.

According to an embodiment, an artificial intelligence semiconductor processor includes a neural network computational accelerator that implements a neural network based on neural network configuration information, and a control circuit that adjusts precision of the neural network configuration information based on device information, and the control circuit adjusts the precision of the neural network configuration information such that neural network processing is performed by using a resource within a resource limit.

As an embodiment, the neural network configuration information includes weight data and feature map data constituting the neural network.

As an embodiment, the precision of the neural network configuration information includes at least one of a sparsity ratio and a quantization format of the neural network configuration information.

As an embodiment, the resource limit includes at least one of a threshold value of a temperature and a threshold value of a power.

As an embodiment, the device information includes a table of consumption quantities of the resource according to the precision of the neural network configuration information.

As an embodiment, the device information further includes a current consumption quantity of the resource.

As an embodiment, the control circuit generates a calibrated table by calibrating the consumption quantities of the resource of the table, based on the current consumption quantity of the resource.

As an embodiment, the device information further includes information of the resource limit.

As an embodiment, the device information further includes a table of accuracy according to precision of layers of the neural network.

As an embodiment, the control circuit adjusts the precision of the neural network configuration information, based on the table.

According to an embodiment, an operating method of an artificial intelligence semiconductor processor includes receiving neural network configuration information, receiving initial device information, receiving real-time device information, and updating the neural network configuration information, based on the initial device information and the real-time device information.

As an embodiment, the updating of the neural network configuration information includes adjusting a sparsity ratio of the neural network configuration information.

As an embodiment, the updating of the neural network configuration information includes adjusting a quantization format of the neural network configuration information.

As an embodiment, the initial device information includes information indicating a resource limit, and the updating of the neural network configuration information includes updating the neural network configuration information such that the artificial intelligence semiconductor processor consumes a resource lower than the resource limit.

As an embodiment, the initial device information includes a table of consumption quantities of a resource according to the updating of the neural network configuration information, and the real-time device information includes a real-time resource consumption quantity.

As an embodiment, the method further includes updating the table based on the real-time resource consumption quantity, and the updating of the neural network configuration information is based on the updated table.

As an embodiment, the initial device information includes a table of accuracy according to the updating of the neural network configuration information, and the updating of the neural network configuration information is based on the table.

### BRIEF DESCRIPTION OF THE FIGURES

The above and other objects and features of the present disclosure will become apparent by describing in detail embodiments thereof with reference to the accompanying drawings.

FIG. 1 illustrates an artificial intelligence semiconductor processor according to an embodiment of the present disclosure.

FIG. 2 illustrates an example of a sparsity and quantization control circuit according to an embodiment of the present disclosure.

FIG. 3 illustrates an example of an operating method of an artificial intelligence semiconductor processor according to an embodiment of the present disclosure.

FIG. 4 illustrates an electronic device according to an embodiment of the present disclosure.

### DETAILED DESCRIPTION

Below, embodiments of the present disclosure may be described in detail and clearly to such an extent that an ordinary one in the art easily implements the present disclosure.

Pattern recognition or classification based on an artificial neural network is implemented by learning parameters constituting the artificial neural network by using learning data, and may be used to calculate a result value according to an intended purpose from input data after the learning is completed. The learning data or the input data may include a variety of data such as image data generated by an image sensor and voice data generated by a voice sensor. The pattern recognition and classification based on the artificial neural network may be utilized in various applications such as a recommendation system based on image and voice recognition.

To increase the precision of recognition of the artificial neural network, the amount of computation to be processed per unit time and a required memory capacity may increase. To efficiently process a large number of operations, an artificial intelligence (AI) semiconductor processor specialized in the structure of the artificial neural network is being developed. The artificial intelligence semiconductor processor may have relatively high parallelism and data reusability compared to a typical semiconductor processor.

In particular, the artificial intelligence semiconductor processor may be utilized in an embedded device of an application requiring high recognition performance, such as autonomous driving or edge mobile. The embedded device has a limited resource compared to a stationary device such as a computer or a server. Accordingly, one of main requirements of the embedded device is low-power implementation.

The artificial intelligence semiconductor processor has to process a large number of operations at high speed for the purpose of satisfying the requirement for a recognition speed such as frames per second (FPS). That is, as the artificial intelligence semiconductor processor operates, an instantaneous maximum power or temperature of the embedded device may increase, and an abnormal operation may occur in the embedded device.

An artificial intelligence semiconductor processor according to an embodiment of the present disclosure may prevent the instantaneous maximum power or temperature of the embedded device from exceeding a set threshold (or maximum) value by adjusting the complexity of the neural network in real time. Accordingly, the reliability of the embedded device may be improved.

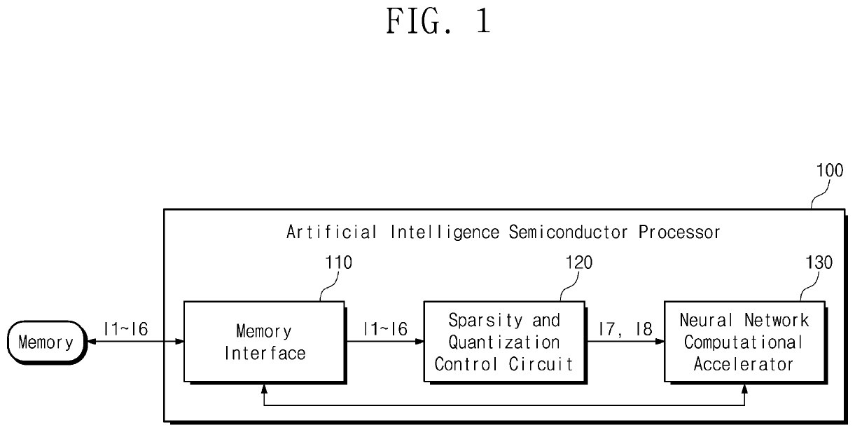

FIG. 1 illustrates an artificial intelligence semiconductor processor 100 according to an embodiment of the present disclosure. Referring to FIG. 1, the artificial intelligence semiconductor processor 100 may include a memory interface 110, a sparsity and quantization control circuit 120, and a neural network computational accelerator 130.

The memory interface 110 may be configured to communicate with an external memory. The memory interface 110 may transfer data received from the external memory to the sparsity and quantization control circuit 120. The memory interface 110 may transfer data provided from the neural network computational accelerator 130 to the external memory.

For example, the memory interface 110 may receive first to sixth information I1 to I6 from the external memory. The first information I1 may include neural network learning parameters, for example, weights. The second information I2 may include neural network intermediate operation data, for example, feature map data. The third information I3 may include consumption of a resource of the neural network computational accelerator 130 according to the sparsity of the first information I1 or the second information I2, for example, a table of temperatures or a table of power values (e.g., instantaneous maximum power values). For example, a temperature may be considered as consuming a resource, in terms of consuming the heat-resistant performance of the artificial intelligence semiconductor processor 100.

The fourth information I4 may include current consumption of the resource of the neural network computational accelerator 130, for example, a measured value of a current temperature or a measured value of a current power (e.g., an instantaneous maximum power). The fifth information I5 may include a threshold value (e.g., a maximum value) of the resource of the neural network computational accelerator 130, for example, a threshold value (e.g., a maximum value) of a temperature or a threshold value (or a maximum value) of a power (e.g., an instantaneous maximum power). The sixth information I6 may include a table of precisions (or performances) according to sparsity ratios of layers of a neural network implemented by the neural network computational accelerator 130. The memory interface 110 may transfer the first to sixth information I1 to I6 received from the external memory to the sparsity and quantization control circuit 120.

The sparsity and quantization control circuit 120 may adjust a sparsity level and a quantization level of a learning parameter based on a power and a temperature. For example, the sparsity and quantization control circuit 120 may adjust the sparsity level or the quantization level such that an instantaneous maximum power or temperature does not exceed a threshold value or is maintained at the threshold value or less.

For example, the sparsity and quantization control circuit 120 may receive the first to sixth information I1 to I6 from the memory interface 110. The sparsity and quantization control circuit 120 may generate seventh and eighth information I7 and I8 by adjusting (or controlling) the sparsity level of the quantization level of the first and second information I1 and I2 based on the third to sixth information I3 to I6. The sparsity and quantization control circuit 120 may input the seventh and eighth information I7 and I8 to the neural network computational accelerator 130.

The neural network computational accelerator 130 may implement a neural network based on the seventh information I7 and the eighth information I8. When the neural network is implemented, the neural network computational accelerator 130 may perform neural network processing on the input data transferred from the external memory through the memory interface 110. The neural network computational accelerator 130 may transfer a result of the neural network processing to the external memory through the memory interface 110.

The sparsity and quantization control circuit 120 may adjust a sparsity level or a quantization level of the seventh information I7 (e.g., weights) or the eighth information I8 (e.g., feature map data) based on a temperature or a power. Accordingly, a temperature or a power (e.g., an instantaneous maximum power) of a device (e.g., an embedded device) including the artificial intelligence semiconductor processor 100 is prevented from reaching (or exceeding) a threshold value.

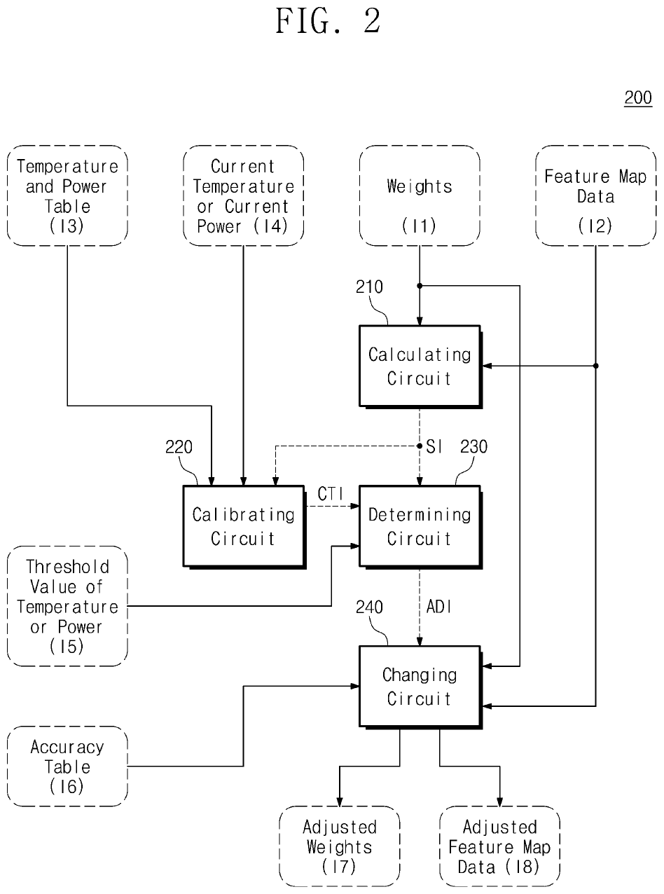

FIG. 2 illustrates an example of a sparsity and quantization control circuit 200 according to an embodiment of the present disclosure. The sparsity and quantization control circuit 200 of FIG. 2 may correspond to the sparsity and quantization control circuit 120 of the artificial intelligence semiconductor processor 100 of FIG. 1.

Referring to FIGS. 1 and 2, the sparsity and quantization control circuit 200 may include a calculating circuit 210, a calibrating circuit 220, a determining circuit 230, and a changing circuit 240. In FIG. 2, solid line arrows may correspond to the first to eighth information I1 to I8, and dotted line arrows may correspond to pieces of information that are used in the sparsity and quantization control circuit 200.

The calculating circuit 210 may receive the first information I1 and the second information I2. The first information I1 may include data of weights of layers of a neural network implemented by the neural network computational accelerator 130. The second information I2 may include feature map data of the layers of the neural network implemented by the neural network computational accelerator 130.

The calculating circuit 210 may calculate the sparsity (e.g., a sparsity ratio) of the first information I1 and the sparsity (e.g., a sparsity ratio) of the second information I2. The sparsity ratio may indicate a ratio of information (e.g., bit) having a value of “0” in bit-precision. The calculating circuit 210 may output the sparsity of the first information I1 and the sparsity of the second information I2 as sparsity information SI.

The calibrating circuit 220 may receive the third information I3 and the fourth information I4. The third information I3 may include a table of temperatures or a table of power values (e.g., instantaneous maximum power values) of the neural network computational accelerator 130 according to the sparsity of the first information I1 or the second information I2. The fourth information I4 may include a measured value of a current temperature or a measured value of a current power (e.g., an instantaneous maximum power).

The calibrating circuit 220 may further receive the sparsity information SI from the calculating circuit 210. The calibrating circuit 220 may detect a pre-predicted (or pre-measured) temperature or power value corresponding to the sparsity of the first information I1 or the second information I2 from the third information I3, by using the sparsity information SI. The calibrating circuit 220 may compare the pre-predicted (or pre-measured) temperature or power value with the fourth information I4.

The calibrating circuit 220 may calibrate the third information I3, based on a comparison result. For example, the calibrating circuit 220 may apply a gain or an offset to the third information I3 such that the predicted (or pre-measured) temperature or power value according to the sparsity of the first information I1 or the second information I2 is the same as a current temperature or power value.

For example, the application of the gain may include multiplying a temperature or power value of the third information I3 and a constant or an arbitrary function together. The application of the offset may include adding a constant or an arbitrary function to the temperature or power value of the third information I3. The calibrating circuit 220 may transfer calibrated table information CTI to the determining circuit 230.

The determining circuit 230 may receive the fifth information I5. The fifth information I5 may include a threshold value of a temperature or a threshold value of a power (e.g., an instantaneous maximum power). The determining circuit 230 may further receive the sparsity information SI from the calculating circuit 210 and may further include the calibrated table information CTI from the calibrating circuit 220.

The determining circuit 230 may determine a sparsity ratio and a quantization format to be applied to the first information I1 and the second information I2 such that a temperature (or heat generation) or a power (e.g., an instantaneous maximum power) of the neural network computational accelerator 130 does not reach the threshold value of the temperature or power of the fifth information I5.

The quantization format may include one of a floating-point data structure and a fixed-point data structure and may include information of a specific data structure and a bit-width to be applied to the specific data structure. For example, when the bit-width information of the quantization format indicates a floating point, the quantization format may include a bit-width of a mantissa and a bit-width of an exponent.

For example, when a current temperature or power value belongs to a first range lower than the threshold value, the determining circuit 230 may increase the sparsity ratio or the bit-width of the quantization format. When the current temperature or power value belongs to a second range close to the threshold value, the determining circuit 230 may decrease the sparsity ratio or the bit-width of the quantization format.

When the current temperature or power value belongs to a third range higher the first range or lower than the second range, the determining circuit 230 may maintain the sparsity ratio or the bit-width of the quantization format. The determining circuit 230 may output the determined sparsity ratio and the determined bit-width of the quantization format as an adjusted information ADI.

The changing circuit 240 may receive the first information I1, the second information I2, and the sixth information I6. The changing circuit 240 may further receive adjusted information ADI from the determining circuit 230. The sixth information I6 may include a table of precisions (or performances) according to sparsity ratios of layers of a neural network implemented by the neural network computational accelerator 130.

The changing circuit 240 may change the sparsity ratio or the quantization format of the first information I1 or the second information I2, based on the adjusted information ADI. For example, in the case where the sparsity ratio decreases, the changing circuit 240 may adjust (e.g., prune), to “0”, weight data or feature map data of a layer having less influence on the precision of the neural network implemented by the neural network computational accelerator 130, based on the sixth information I6.

In the case where the sparsity ratio increases, the changing circuit 240 may adjust weight data or feature map data of a layer having larger influence on the precision of the neural network implemented by the neural network computational accelerator 130 by using the sixth information I6, to a value, not “1” or “0”. The changing circuit 240 may adjust the sparsity ratio or the quantization format of the second information I2 so as to be output as the eighth information I8.

According to the present disclosure, a function of adjusting a temperature or power in real time may be added to the artificial intelligence semiconductor processor 100 by only adding the sparsity and quantization control circuit 200 within the artificial intelligence semiconductor processor 100.

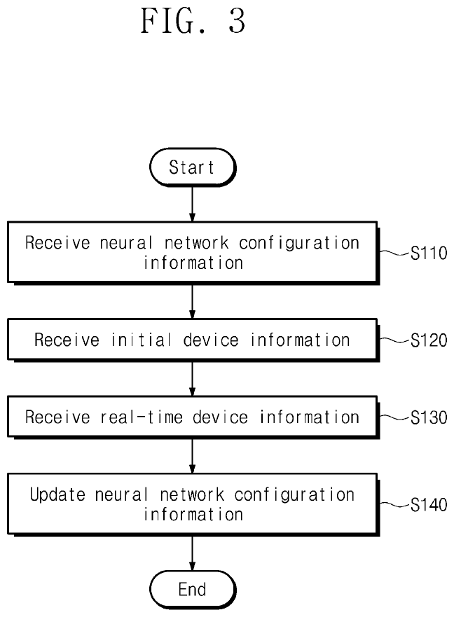

FIG. 3 illustrates an example of an operating method of the artificial intelligence semiconductor processor 100 according to an embodiment of the present disclosure. Referring to FIGS. 1, 2, and 3, in operation S110, the artificial intelligence semiconductor processor 100 may receive neural network configuration information. The neural network configuration information may include the first information I1 and the second information I2.

In operation S120, the artificial intelligence semiconductor processor 100 may receive initial device information. The initial device information may include the third information I3, the fifth information I5, and the sixth information I6. In an embodiment, the artificial intelligence semiconductor processor 100 may implement a neural network, based on the neural network configuration information and the initial device information. The artificial intelligence semiconductor processor 100 may perform various neural network processing, based on the implemented neural network.

In operation S130, the artificial intelligence semiconductor processor 100 may receive real-time device information. The real-time device information may include the fourth information I4. The artificial intelligence semiconductor processor 100 may determine a current state by comparing the neural network configuration information, the initial device information, and the real-time device information.

For example, the current state may indicate whether a temperature or power (e.g., instantaneous maximum power) value will increase, will decrease, or will be maintained. In operation S140, the artificial intelligence semiconductor processor 100 may update the neural network configuration information, based on the current state.

For example, the artificial intelligence semiconductor processor 100 may adjust the precision of the neural network configuration information. To adjust the precision of the neural network configuration information may include adjusting a sparsity ratio or a quantization format of the neural network configuration information. The artificial intelligence semiconductor processor 100 may update the neural network configuration information by adjusting at least one or all of the sparsity ratio and the quantization format of the neural network configuration information.

In an embodiment, the artificial intelligence semiconductor processor 100 may update the neural network configuration information so as to perform neural network processing by using (or consuming) a resource within a resource limit. For example, the resource limit may include a threshold value of a temperature or a power (or instantaneous maximum power).

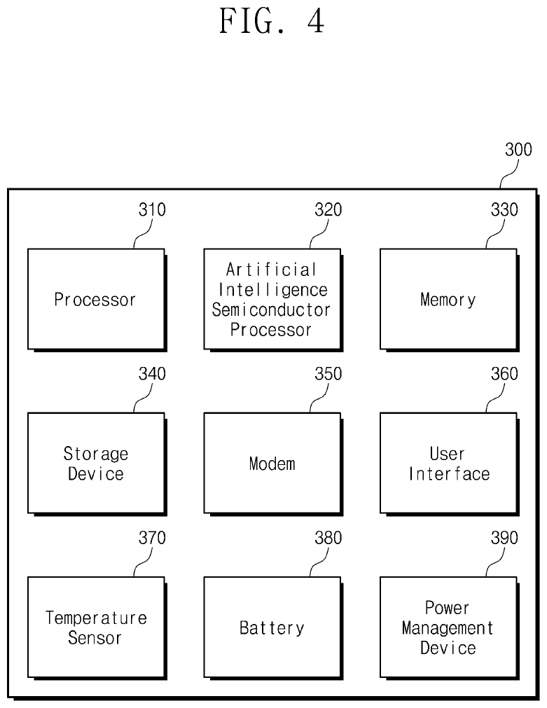

FIG. 4 illustrates an electronic device 300 according to an embodiment of the present disclosure. Referring to FIG. 4, the electronic device 300 may include a processor 310, an artificial intelligence semiconductor processor 320, a memory 330, a storage device 340, a modem 350, a user interface 360, a temperature sensor 370, a battery 380, and a power management device 390.

The processor 310 may execute an operating system and various applications. The processor 310 may include a central processing unit or an application processor. The processor 310 may store data necessary for a configuration of a neural network in the memory 330 and may request the artificial intelligence semiconductor processor 320 to configure the neural network based on the corresponding data.

The processor 310 may store data necessary for neural network processing in a specific region of the memory 330 and may request the artificial intelligence semiconductor processor 320 to perform the neural network processing on the corresponding data.

The artificial intelligence semiconductor processor 320 may correspond to the artificial intelligence semiconductor processor 100 described with reference to FIGS. 1 to 3. In response to a request of the processor 310, the artificial intelligence semiconductor processor 320 may configure the neural network by using the data stored in the specific region of the memory 330. In response to a request of the processor 310, the artificial intelligence semiconductor processor 320 may perform the neural network processing on the data stored in the specific region of the memory 330.

The memory 330 may be a main memory of the electronic device 300. The memory 330 may include various random access memories such as a static random access memory, a dynamic random access memory, a phase-change random access memory, a ferroelectric random access memory, a magnetic random access memory, and a resistive random access memory.

The storage device 340 may store the original of various codes or data that are executed (or processed) by the processor 310 or the artificial intelligence semiconductor processor 320. The storage device 340 may back up various codes or data generated by the processor 310 or the artificial intelligence semiconductor processor 320. The storage device 340 may include a solid state drive.

The modem 350 may be configured to exchange data with an external device. The modem 350 may communicate with the external device, based on at least one of various wireless communication protocols such as Wi-Fi, 5G, LTE, and Bluetooth and various wired communication protocols such as USB, NVMe, PCIe, SATA, and UFS.

The user interface 360 may exchange information with a user. The user interface 360 may include various user output interfaces, which provide information to the user, such as a monitor, a display, a printer, a speaker, and a projector. The user interface 360 may include various user input interfaces, which receive information from the user, such as a mouse, a keyboard, a touch pad, a microphone, and a sensor.

The temperature sensor 370 may include two or more sensors configured to sense temperatures of various parts present inside or outside the electronic device 300. At least one of the two or more sensors may be coupled to the artificial intelligence semiconductor processor 320 to sense a temperature of the artificial intelligence semiconductor processor 320 and may store a sensing result in the memory 330 as a portion of the fourth information I4.

The battery 380 may store a power necessary to drive the electronic device 300. The battery 380 may be discharged by providing the power to the power management device 390 and may be charged by receiving a power from the power management device 390.

The power management device 390 may manage a power that is supplied to the components of the electronic device 300. The power management device 390 may monitor a power (e.g., a real-time instantaneous maximum power) of the artificial intelligence semiconductor processor 320 and may store the monitored power value in the memory 330 as a portion of the fourth information I4.

In the above embodiments, components according to the present disclosure are described by using the terms “first”, “second”, “third”, etc. However, the terms “first”, “second”, “third”, etc. may be used to distinguish components from each other and do not limit the present disclosure. For example, the terms “first”, “second”, “third”, etc. do not involve an order or a numerical meaning of any form.

In the above embodiments, components according to embodiments of the present disclosure are referenced by using blocks. The blocks may be implemented with various hardware devices, such as an integrated circuit, an application specific IC (ASIC), a field programmable gate array (FPGA), and a complex programmable logic device (CPLD), firmware driven in hardware devices, software such as an application, or a combination of a hardware device and software. Also, the blocks may include circuits implemented with semiconductor elements in an integrated circuit, or circuits enrolled as an intellectual property (IP).

According to the present disclosure, an artificial intelligence semiconductor processor may dynamically update neural network configuration information based on a resource limit. Accordingly, an artificial intelligence semiconductor processor performing neural network processing by utilizing the limited resource and an operating method of the artificial intelligence semiconductor processor are provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An artificial intelligence semiconductor processor comprising:
a neural network computational accelerator configured to implement a neural network based on neural network configuration information; and
a control circuit configured to adjust precision of the neural network configuration information based on device information,
wherein the control circuit adjusts the precision of the neural network configuration information such that neural network processing is performed by using a resource within a resource limit.

2. The artificial intelligence semiconductor processor of claim 1, wherein the neural network configuration information includes weight data and feature map data constituting the neural network.

3. The artificial intelligence semiconductor processor of claim 1, wherein the precision of the neural network configuration information includes at least one of a sparsity ratio and a quantization format of the neural network configuration information.

4. The artificial intelligence semiconductor processor of claim 1, wherein the resource limit includes at least one of a threshold value of a temperature and a threshold value of a power.

5. The artificial intelligence semiconductor processor of claim 1, wherein the device information includes a table of consumption quantities of the resource according to the precision of the neural network configuration information.

6. The artificial intelligence semiconductor processor of claim 5, wherein the device information further includes a current consumption quantity of the resource.

7. The artificial intelligence semiconductor processor of claim 6, wherein the control circuit generates a calibrated table by calibrating the consumption quantities of the resource of the table, based on the current consumption quantity of the resource.

8. The artificial intelligence semiconductor processor of claim 7, wherein the device information further includes information of the resource limit.

9. The artificial intelligence semiconductor processor of claim 1, wherein the device information further includes a table of accuracy according to precision of layers of the neural network.

10. The artificial intelligence semiconductor processor of claim 9, wherein the control circuit adjusts the precision of the neural network configuration information, based on the table.

11. An operating method of an artificial intelligence semiconductor processor, the method comprising:
receiving neural network configuration information;
receiving initial device information;
receiving real-time device information; and
updating the neural network configuration information, based on the initial device information and the real-time device information.

12. The method of claim 11, wherein the updating of the neural network configuration information includes:
adjusting a sparsity ratio of the neural network configuration information.

13. The method of claim 11, wherein the updating of the neural network configuration information includes:
adjusting a quantization format of the neural network configuration information.

14. The method of claim 11, wherein the initial device information includes information indicating a resource limit, and
wherein the updating of the neural network configuration information includes:
updating the neural network configuration information such that the artificial intelligence semiconductor processor consumes a resource lower than the resource limit.

15. The method of claim 11, wherein the initial device information includes a table of consumption quantities of a resource according to the updating of the neural network configuration information, and
wherein the real-time device information includes a real-time resource consumption quantity.

16. The method of claim 15, further comprising:
updating the table based on the real-time resource consumption quantity, and
wherein the updating of the neural network configuration information is based on the updated table.

17. The method of claim 11, wherein the initial device information includes a table of accuracy according to the updating of the neural network configuration information, and
wherein the updating of the neural network configuration information is based on the table.
